(19) United States
(12) Patent Application Publication
(10) Pub. No.: US 2007/0228779 A1
(43) Pub. Date: Oct. 4, 2007

(54) SLIDING ROOF SYSTEM

(76) Inventor: Klaus Stallfort, Wehrheim (DE)

Correspondence Address: CARLSON, GASKEY & OLDS, P.C., 400 WEST MAPLE ROAD, SUITE 350, BIRMINGHAM, MI, 48009, US

(21) Appl. No.: 11/690,244

(22) Filed: Mar. 23, 2007

(30) Foreign Application Priority Data
Apr. 4, 2006 (EP) 06 007 097.6

(51) Int. Cl. B60J 7/185

(52) U.S. Cl. 296/224

(57) ABSTRACT

A sliding roof system includes at least one guide rail, a cover support, and a carriage that can be shifted in the guide rail and with which the cover support is connected. The sliding roof system includes a locking element that is able to engage the cover support and can lock or release the cover support.

### RELATED APPLICATIONS

The application claims priority to European Patent Application No. 06 007 097.6, which was filed on Apr. 4, 2006.

### BACKGROUND OF THE INVENTION

The invention relates to a sliding roof system comprising at least one guide rail, a cover support, and a carriage that can be shifted in the guide rail and with which the cover support is connected.

Sliding roof systems are generally known. They serve to shift at least one cover (made from sheet metal, plastic, or glass, for instance) between a closed position and an open position. In the closed position, an opening in a vehicle roof is closed. In the open position of the cover, such opening will be exposed to a greater or lesser extent. The cover may also assume a venting position in which a rear edge of the cover is raised and a front edge of the cover is blocked in a lowered position.

From DE 10 2004 018 461, there is known a sliding roof system that includes two shifting levers. As the cover opens, a front shifting lever prevents the front edge of the cover from being raised, while a rear shifting lever raises the rear edge of the cover. The front shifting lever subsequently is able to release the front edge of the cover and permit a raising of the front edge in this way.

It is the object of the invention to provide a sliding roof system of the type initially mentioned but which allows a simpler locking of the front edge of the cover.

### SUMMARY OF THE INVENTION

To solve this problem, a locking element is provided in a sliding roof system of the type initially mentioned, where the locking element is able to engage a cover support and can lock or release the cover support. The locking element locks a cover, in particular a front edge of the cover, in a closed position and in a venting position and prevents movement of the front edge in a direction z. In the prior art configuration, a second shifting lever was necessary to this end, which now can be omitted. Thus, construction is simpler and more cost-efficient, and situations where a vehicle occupant may get pinched are more unlikely.

In one example, the locking element is coupled to the carriage. As a result, a separate carriage is not required, which reduces cost.

A sliding piece can be provided that is supported in a guide rail at plural points. A plural (e.g., double) and, thus, stable supporting of the sliding piece that is engaged by the locking element prevents a movement of the locking element in the direction z and thus allows a safe locking of the cover, in particular a locking of the front edge of the cover.

At least one resilient element can be provided. The resilient element may be provided between the locking element and the carriage, on a raising slot, or on a front area of the locking element. In this way, the sliding roof system can be realized to be entirely free of play in a horizontal direction.

According to one embodiment, the cover support is directly connected with the carriage, i.e., a rear shifting lever is not provided. Thus, fewer parts are required, making the sliding roof system more cost effective.

According to a further embodiment, a shifting lever is provided which connects the cover support with the carriage. The shifting lever of the sliding roof system produces a desired and necessary lifting movement by virtue of its direct coupling with the carriage. This is why a sliding roof system can be achieved that has a low overall height.

These and other features of the present invention can be best understood from the following specification and drawings, the following of which is a brief description.

### BRIEF DESCRIPTION OF THE DRAWINGS

FIG. 1 is a schematic, perspective view of a vehicle roof including a sliding roof system according to the invention.

FIG. 2 is a schematic view of a guide rail with components, arranged therein, of a sliding roof system of the invention according to a first embodiment, where a cover is in a closed position.

FIG. 3 is a view corresponding to FIG. 2, but with the cover in a venting position.

FIG. 4 is a view corresponding to FIG. 2, where the cover is in a position fully raised outwardly of a vehicle roof.

FIG. 5 is a sectional view along line V-V in FIG. 4.

FIG. 6 is a schematic view of a guide rail with components, arranged therein, of a sliding roof system of the invention according to a second embodiment, where the cover is in the closed position.

FIG. 7 is a view corresponding to FIG. 6, but with the cover in the venting position.

FIG. 8 is a view corresponding to FIG. 6, where the cover is in a position fully raised outwardly of the vehicle roof.

FIG. 9 shows an enlarged detail of an area designated with X in FIG. 6, with a spring element in a first variant.

FIG. 10 shows an enlarged detail of an area designated with Y in FIG. 6, with a spring element in a second variant.

FIG. 11 shows an enlarged detail of the area designated with Y in FIG. 6, with a spring element in a third variant.

FIG. 12 is a schematic view of a guide rail with components, arranged therein, of a sliding roof system of the invention according to a third embodiment where is in the closed position.

### DETAILED DESCRIPTION OF THE PREFERRED EMBODIMENT

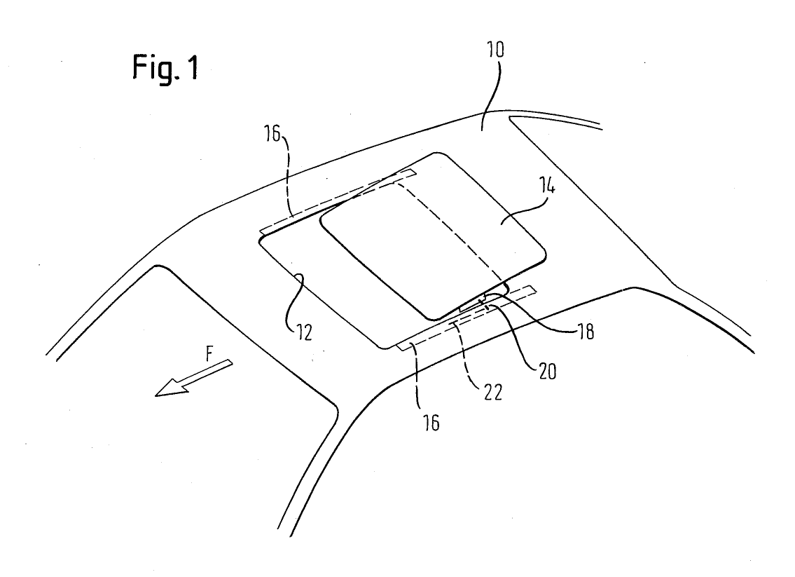

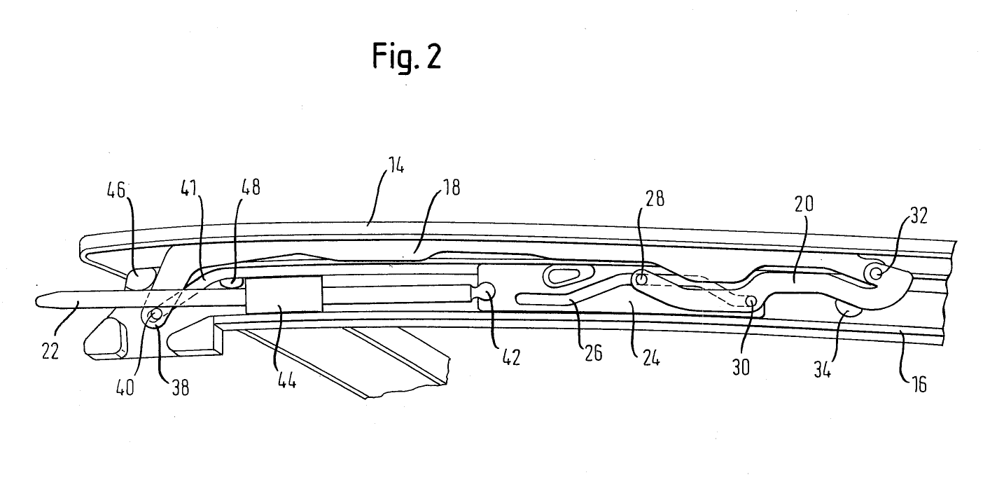

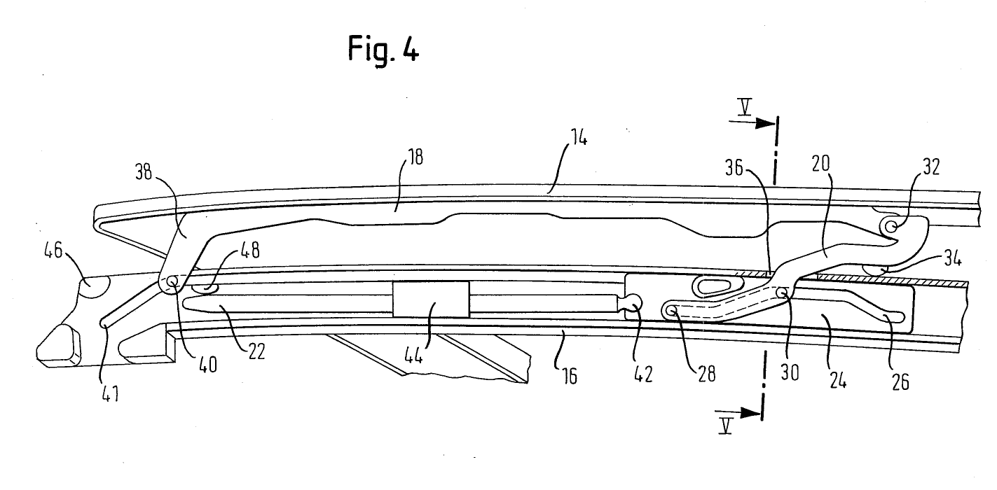

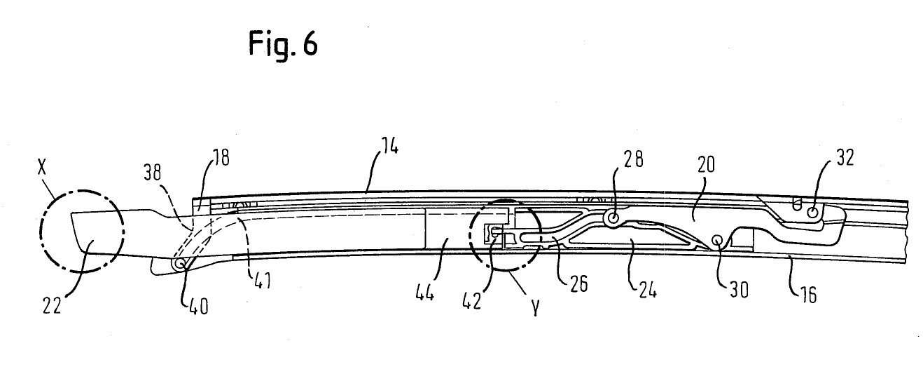

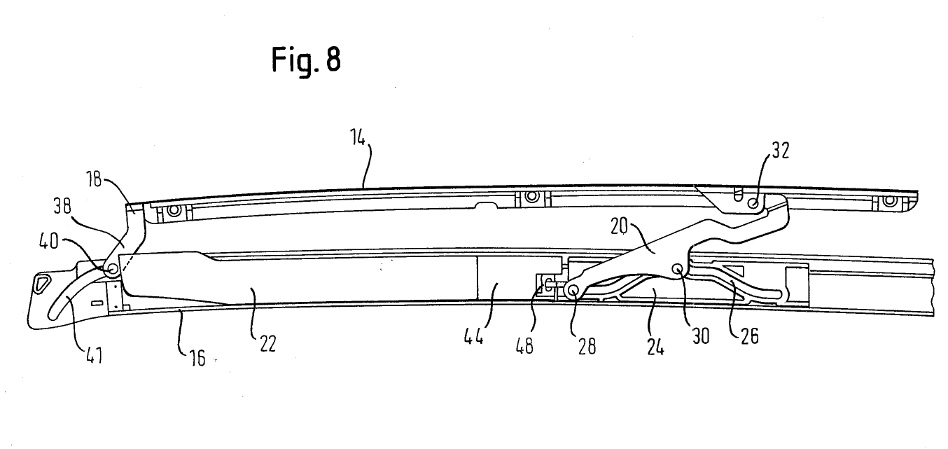

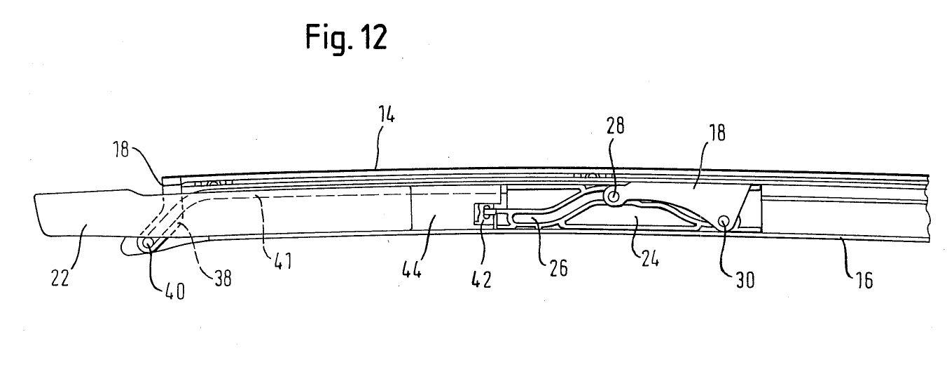

FIG. 1 shows a vehicle roof 10 with an opening 12. A cover 14 is associated with the opening 12 and can be moved between a closed position in which the cover 14 closes the opening 12, and an open position. Associated with the cover 14 is a sliding roof system, the essential components of which are two guide rails 16, two cover supports 18 (only one is shown), and two locking elements 22 (only one is shown), the latter engaging the cover support 18 and being capable of locking or releasing the cover support 18 in direction z (a vertical direction). FIG. 1 further includes two shifting levers 20 (only one is shown), which are constituents of a first (FIGS. 2 to 5) and second (FIGS. 6 to 11) embodiment. A third embodiment, shown in FIG. 12, however, does not include shifting levers 20.

In the following, the first embodiment, which is shown in FIGS. 2 to 5, will be explained.

In this example, the cover supports 18 are realized as separate components that are firmly attached to the cover 14. It is likewise possible, however, that the cover supports 18 are formed by inlay pieces that are molded in the cover 14, for instance, or by fastening lugs integrally formed with the cover 14.

The two guide rails 16 extend along longitudinal edges of the opening 12, i.e., from a front to a rear related to a direction of travel F of the vehicle. The guide rails 16 are usually formed by a section made of an aluminum alloy. A carriage 24 (see FIG. 2) is movably arranged in each of the guide rails 16. Coupled with the carriage 24 is a drive mechanism (not illustrated), for example a metal cable that is resistant to buckling and tensile stress, and which is driven by a drive motor (not illustrated). The carriage 24 is usually made of plastic. As the carriage 24 is designed to be relatively short, the carriage 24 can be employed in the guide rails 16 with different curvatures.

Coupled with the carriage 24 is the shifting lever 20, with a slotted guide being used for coupling. The slotted guide is formed by a raising slot 26 in the carriage 24. The raising slot 26 is engaged by pins 28, 30 that are provided on the shifting lever 20. The raising slot 26 is arranged on a rear end of the carriage 24 (related to the direction of travel F of the vehicle) and initially extends horizontally, as seen from the front to the rear, then slopes upwardly, subsequently extends again horizontally and finally descends obliquely downward.

The pin 28 is arranged at a front end of the shifting lever 20, which is designed as a flat strip. The pin 30 is situated behind the pin 28 (related to the direction of travel F). The distance between the two pins 28, 30 is smaller than half the length of the shifting lever 20. At a rear end opposite the pin 28, the shifting lever 20 is connected with the cover support 18 by a stud 32.

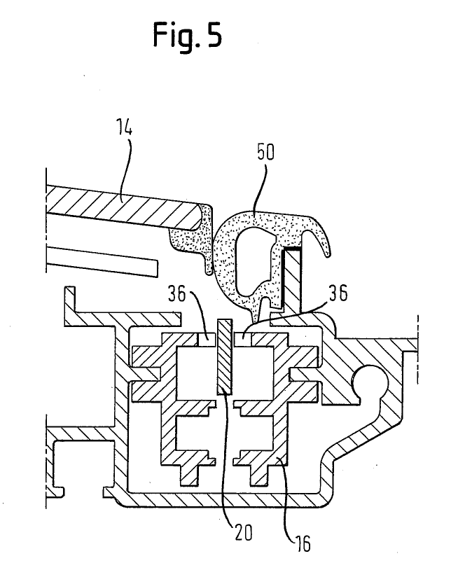

Between the stud 32 and the pin 30, the shifting lever 20 has a transverse web 34 that is able to pass through a recess 36 (see FIG. 5) in the guide rail 16 when the shifting lever 20 is being raised or lowered. The transverse web 34 may rest on an upper edge of the guide rail 16.

A front end of the carriage 24 is coupled to a rear end of a locking element 22 by a joint 42, which is realized as a ball joint or swivel joint, for instance. The locking element 22 can engage the cover support 18, in particular a guide pin 40 of the cover support 18, and lock or release the cover support 18. The guide pin 40 is attached at a lower end of a guide lug 38 that is provided on the front end of the cover support 18. The guide pin 40 engages a guiding slot 41, which starting from the front end of the guide rail 16 first extends obliquely upwards to the rear, and subsequently extends in a straight line along the guide rail 16.

A sliding piece 44 engages a middle of the locking element 22 and can be moved in the guide rail 16. The sliding piece 44 itself has no drive mechanism, but can be shifted in the guide rail 16 with the carriage 24 due to a connection via the locking element 22. The sliding piece 44 could also have its own drive mechanism (not shown).

Provided at the front end of the guide rail 16 are abutments 46, 48. As seen in the direction of travel F, the abutment 48 is attached behind the abutment 46 and the guiding slot 41. The locking element 22 can engage the abutments 46, 48.

FIG. 2 shows the carriage 24 in a position that corresponds to the closed position of the cover 14. The carriage 24 is fully shifted to the front so that the pin 30 is at the rear end of the raising slot 26. The guide pin 40 of the cover support 18 is at the front, lower end of the guiding slot 41. The locking element 22 is fully shifted to the front by the carriage 24 and is situated between the abutments 46, 48 and the guide pin 40 of the cover support 18. This prevents a movement of the guide pin 40 and, thus, of the front edge of the cover 14 in a vertical direction. In this position, the cover support 18 and the cover 14 are locked in the closed position.

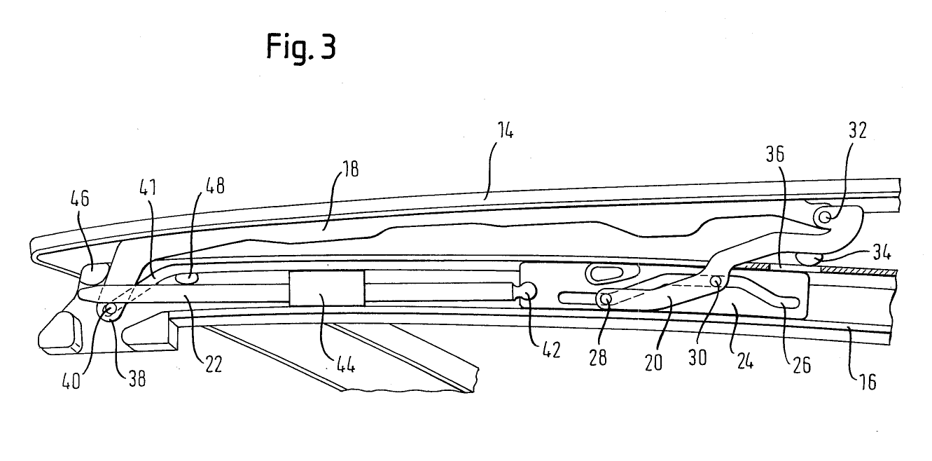

When the cover 14 is opened, the carriage 24 is shifted rearwardly from the position shown in FIG. 2 to the position shown in FIG. 3. This has the effect that the rear end of the shifting lever 20, which is connected with the cover support 18, is swiveled upwards because the pin 30 is moved upward in the raising slot 26, while the pin 28 of the shifting lever 20 is moved downward. Thus, the shifting lever 20 performs a swiveling motion around a point between the two pins 28, 30. The rear end of the cover support 18 will be lifted thereby, and the transverse web 34 of the shifting lever 20 passes through the recess 36 in the guide rail 16 and rests on the upper edge of the guide rail 16.

As the carriage 24 shifts, the locking element 22 is articulated thereon and the sliding piece 44 likewise will be moved to the rear. Here, a length of the locking element 22 is selected such that the guide pin 40 of the cover support 18 continues to be locked. In this manner, the guide pin 40 continues to be prevented from performing a movement in a vertical direction.

The position shown in FIG. 3 is usually referred to as a venting position because only the rear edge of the cover 14 is lifted, so that a venting of a vehicle interior space is achieved by a gap.

If the cover 14 is to be opened to a greater extent, the carriage 24 is shifted further to the rear. In doing so, the shifting lever 20 essentially remains in the position known from FIG. 2, while the guide lug 38 of the cover support 18 will be lifted. This is in particular due to the fact that the guide pin 40 has been released by the locking element 22, so that the guide pin 40 is lifted in the guiding slot 41 until the guide pin 40 enters the horizontally extending portion of the guiding slot 41.

After having been released by the locking element 22, the guide lug 38 can be shifted to the rear by the carriage 24, so that the cover 14 fully exposes the opening 12 in the vehicle roof 10. In this process, the transverse web 34 of the shifting lever 20 likewise is moved to the rear and is away from the recess 36, so that the rear edge of the cover 14 remains in the raised position.

When the cover 14 is to be closed again, the carriage 24 is shifted to the front, whereupon a reversed motion sequence of the shifting lever 20, the sliding piece 44, and of the locking element 22 will occur, until the cover 14 has reached the closed position in which the cover support 18 is locked by the locking element 22.

The locking element 22 is able to lock and release the cover support 18. The locking element 22 therefore replaces a front shifting lever. As only one shifting lever 20 is provided, there only is one lever which has to penetrate a seal 50 (FIG. 5) surrounding the roof opening 12, so that lower friction occurs.

In the following, the second embodiment shown in FIGS. 6 to 11 will be explained. The same reference numerals will be used for the components known from the first embodiment, and in this respect reference is made to the above explanations.

The second embodiment differs from the first embodiment in particular in the fact that no abutments 46, 48 are provided to cooperate with the locking element 22. Further, the shifting lever 20 does not have a transverse web 34.

Here too, the locking element 22 is articulated to the carriage 24 via joint 42. The sliding piece 44, which can be shifted in the guide rail 16 and is engaged by the locking element 22, is supported in this embodiment at plural points, in particular at two points. Statically seen, the locking element 22 acts as a cantilever supported on two pillars. The double support results in the locking element 22 being rigid and immovable in the direction z. Thus, the locking element 22 can lock or release the guide pin 40 of the cover support 18 in direction z.

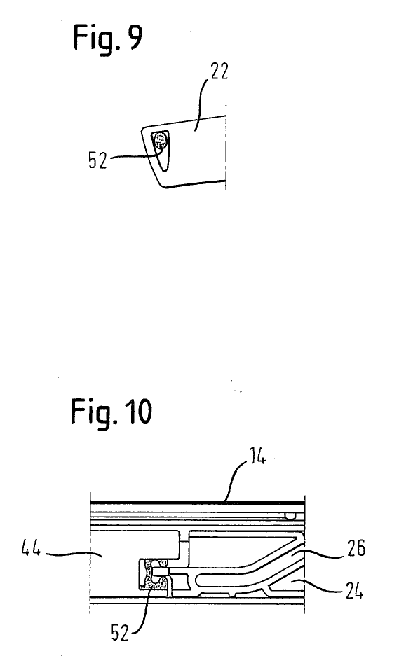

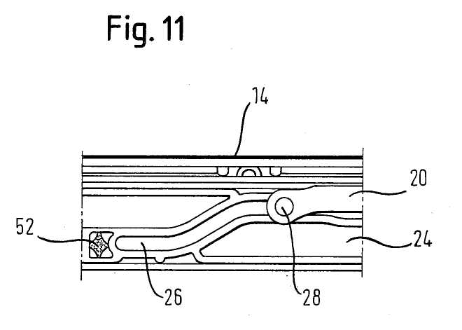

In contrast to the first embodiment, one or more resilient elements 52 (see FIGS. 9 to 11) are provided. The resilient elements 52 are designed as bow springs, for instance, and are provided at the front end of the locking element 22 (see the variant shown in FIG. 9) between the locking element 22 and the carriage 24 (see the variant shown in FIG. 10), or at the raising slot 26 (see the variant shown in FIG. 11), and make it possible to realize the sliding roof system so as to be entirely free of play in a horizontal direction.

The mode of operation of the sliding roof system essentially is identical to that of the first embodiment. The mode of operation is only different in the respect that the locking element 22 engages the guide pin 40 in all positions of the cover 14.

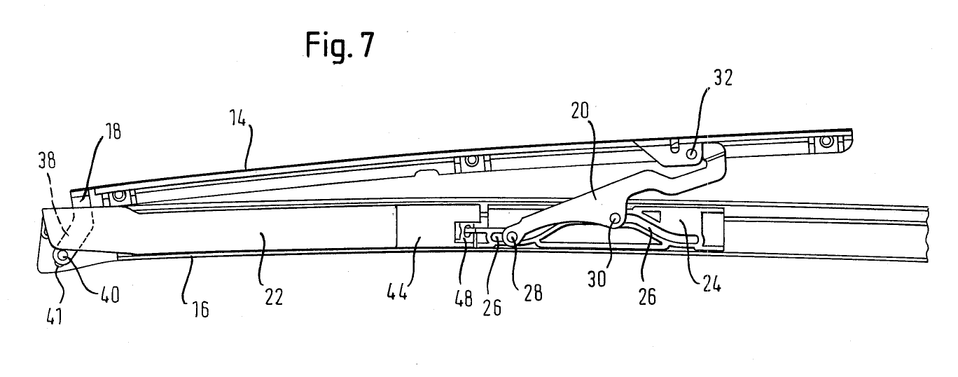

When the cover 14 is opened, the carriage 24 is shifted rearwardly from the position shown in FIG. 6 to the position shown in FIG. 7. The rear end of the shifting lever 20, which is connected with the cover support 18, will be swiveled upwards in this process, because the pin 30 moves upwards in the raising slot 26, while the pin 28 of the shifting lever 20 moves downwards. Thus, the shifting lever 20 performs a swiveling motion, and the rear end of the cover support 18 will be lifted.

As the carriage 24 shifts, the rigid locking element 22 that is articulated on the carriage 24 and is supported at plural points, and the sliding piece 44 will be moved to the rear. The length and rigidity of the locking element 22 allows the guide pin 40 of the cover support 18 to continue to be prevented from performing a movement in the direction z.

When the cover 14 is to be opened to a greater extent, the carriage 24 is further shifted to the rear. In this process, the shifting lever 20 substantially remains in the position known from FIG. 7, while the guide lug 38 of the cover support 18 is lifted. This is in particular due to the fact that the guide pin 40 has been released by the locking element 22, so that the guide pin 40 is lifted in the guiding slot 41 until the guide pin 40 enters the horizontally extending portion of the guiding slot 41. “Released” in this example means that the locking element 22 indeed continues to engage the guide pin 40, but the length of the locking element 22 is selected such that the latter shifts in the guiding slot 41.

After being released by the locking element 22, the guide lug 38 can be shifted to the rear by the carriage 24, so that the cover 14 fully exposes the opening 12 in the vehicle roof 10.

When the cover 14 is to be closed again, the carriage 24 is shifted to the front, whereupon a reversed motion sequence of the shifting lever 20, the sliding piece 44, and the locking element 22 will occur until the cover 14 has reached the closed position in which the cover support 18 is locked by the locking element 22.

In the following, the third embodiment schematically shown in FIG. 12 will be explained. The same reference numerals will be used for the components that are already known, and in this respect reference is made to the above explanations.

The third embodiment differs from the second embodiment only in the respect that the shifting lever 20 is omitted. This is because the cover support 18 directly engages the carriage 24, i.e., the pins 28, 30 attached to the cover support 18 engage the raising slot 26 of the carriage 24. As the shifting lever 20 is omitted, the vertical travel of the cover 14 has to be brought about solely by the raising slot 26, whereby the overall height of the sliding roof system increases. The sliding roof system which is designed in this way, however, has fewer components.

The mode of operation differs from that of the second embodiment only in the respect that the raising motion of the cover 14 is not produced by a shifting lever, but merely by the raising slot 26.

Moreover, a combination of the embodiments is possible. It would also be possible to support the sliding piece 44 of the first embodiment at plural points, or that the shifting lever 20 of the first embodiment is omitted.

The locking element 22 and the carriage 24 at both sides of the opening 12 can be separately attached to the guide rails 16 or can be attached as a common, pre-assembled unit.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A sliding roof system comprising:
at least one guide rail;
a cover support;
a carriage shiftable in the at least one guide rail and connected to the cover support; and
a locking element that engages the cover support and can lock or release the cover support.

2. The sliding roof system according to claim 1, wherein the cover support has a guide pin which can be engaged by the locking element.

3. The sliding roof system according to claim 1, wherein the locking element is coupled to the carriage.

4. The sliding roof system according to claim 1, wherein the locking element is coupled to the carriage a joint.

5. The sliding roof system according to claim 1, including a sliding piece that is shifted in the at least one guide rail and is engaged by the locking element.

6. The sliding roof system according to claim 5, wherein the sliding piece is supported in the at least one guide rail at plural points.

7. The sliding roof system according to claim 2, wherein the guide pin on the cover support engages the locking element in all positions.

8. The sliding roof system according to claim 1, including at least one resilient element.

9. The sliding roof system according to claim 1, including at least one abutment on the at least one guide rail that cooperates with the locking element.

10. The sliding roof system according to claim 1, wherein the cover support is directly connected with the carriage.

11. The sliding roof system according to claim 1, including a shifting lever that connects the cover support with the carriage.

12. The sliding roof system according to claim 11, wherein the shifting lever comprises a flat strip.

13. The sliding roof system according to claim 11, wherein the shifting lever has a transverse web and the at least one guide rail includes a recess, the transverse web being capable of passing through the recess such that the shifting lever is able to move between a lowered position and a raised position.
